(19) United States
(12) Patent Application Publication
(10) Pub. No.: US 2026/0261595 A1
(43) Pub. Date: Sep. 3, 2026

(54) ENHANCED POWER LINE COMMUNICATION RACK MANAGEMENT WITH DATA PROCESSING UNITS

(71) Applicant: Dell Products L.P., Round Rock, TX (US)

(72) Inventors: Yayun LIU, Austin, TX (US); Erik P. SMITH, Douglas, MA (US)

(73) Assignee: Dell Products L.P., Round Rock, TX (US)

(21) Appl. No.: 19/066,694

(22) Filed: Feb. 28, 2025

(51) Int. Cl. H04L 67/06; H04B 3/54

(52) U.S. Cl. CPC H04L 67/06; H04B 3/54

(57) ABSTRACT

A system may include a communications network and a plurality of information handling systems, wherein each information handling system of the plurality of information handling systems is communicatively coupled to the communications network. Each information handling system of the plurality of information handling systems may include a processor and a data processing unit for offloading functions of the processor and configured to receive via the communications network a respective data portion of a file intended for a target information handling system of the plurality of information handling systems and transmit the respective data portion to the data processing unit of the target information handling system.

### TECHNICAL FIELD

The present disclosure relates in general to information handling systems, and more particularly to systems and methods for enhancing power line communication in a server rack with data processing units.

### BACKGROUND

As the value and use of information continues to increase, individuals and businesses seek additional ways to process and store information. One option available to users is information handling systems. An information handling system generally processes, compiles, stores, and/or communicates information or data for business, personal, or other purposes thereby allowing users to take advantage of the value of the information. Because technology and information handling needs and requirements vary between different users or applications, information handling systems may also vary regarding what information is handled, how the information is handled, how much information is processed, stored, or communicated, and how quickly and efficiently the information may be processed, stored, or communicated. The variations in information handling systems allow for information handling systems to be general or configured for a specific user or specific use such as financial transaction processing, airline reservations, enterprise data storage, or global communications. In addition, information handling systems may include a variety of hardware and software components that may be configured to process, store, and communicate information and may include one or more computer systems, data storage systems, and networking systems.

Deploying computing infrastructure, including artificial-intelligence enabled infrastructure, is often challenging due to high costs, time-sensitive workloads, and the need for rapid deployment of new hardware. In addition to deployment challenges, customers may face difficulties in managing infrastructure on a node-by-node basis and may prefer to manage groups of nodes (which may be referred to as “pods”) which include compute, network, power, and cooling elements. A solution may involve integrating a rack or pod controller to automate configuration and monitoring. However, without a management network, automation may be hindered, and critical functions may fail during network outages, creating potential safety risks.

### SUMMARY

In accordance with the teachings of the present disclosure, the disadvantages and problems associated with deploying and maintaining information handling systems in a server rack may be reduced or eliminated.

In accordance with embodiments of the present disclosure, a system may include a communications network and a plurality of information handling systems, wherein each information handling system of the plurality of information handling systems is communicatively coupled to the communications network. Each information handling system of the plurality of information handling systems may include a processor and a data processing unit for offloading functions of the processor and configured to receive via the communications network a respective data portion of a file intended for a target information handling system of the plurality of information handling systems and transmit the respective data portion to the data processing unit of the target information handling system.

In accordance with these and other embodiments of the present disclosure, a method may be provided for a system comprising a communications network and a plurality of information handling systems, wherein each information handling system of the plurality of information handling systems is communicatively coupled to the communications network, and each information handling system of the plurality of information handling systems comprises a processor and a data processing unit for offloading functions of the processor. The method may include receiving by the data processing unit of each information handling system, via the communications network, a respective data portion of a file intended for a target information handling system of the plurality of information handling systems and transmitting by the data processing unit of each information handling system, the respective data portion to the data processing unit of the target information handling system.

Technical advantages of the present disclosure may be readily apparent to one skilled in the art from the figures, description and claims included herein. The objects and advantages of the embodiments will be realized and achieved at least by the elements, features, and combinations particularly pointed out in the claims.

It is to be understood that both the foregoing general description and the following detailed description are examples and explanatory and are not restrictive of the claims set forth in this disclosure.

### BRIEF DESCRIPTION OF THE DRAWINGS

A more complete understanding of the present embodiments and advantages thereof may be acquired by referring to the following description taken in conjunction with the accompanying drawings, in which like reference numbers indicate like features, and wherein:

FIG. 1 illustrates a block diagram of an example system, in accordance with embodiments of the present disclosure;

FIG. 2 illustrates a block diagram of an example information handling system, in accordance with embodiments of the present disclosure; and

FIG. 3 illustrates a flow chart of an example method for enhanced power line communication with data processing units, in accordance with embodiments of the present disclosure.

### DETAILED DESCRIPTION

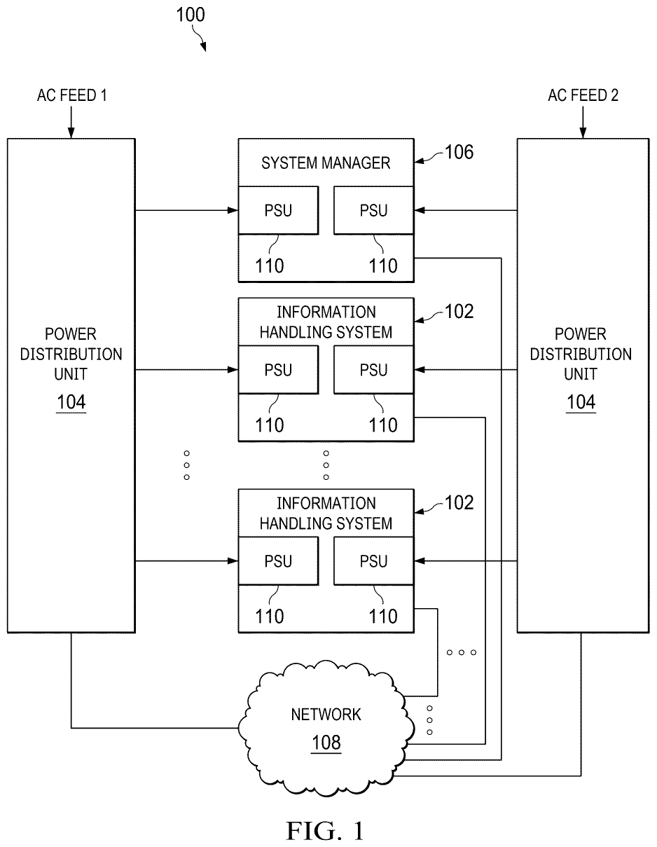

Preferred embodiments and their advantages are best understood by reference to FIGS. 1 through 3, wherein like numbers are used to indicate like and corresponding parts.

For the purposes of this disclosure, an information handling system may include any instrumentality or aggregate of instrumentalities operable to compute, classify, process, transmit, receive, retrieve, originate, switch, store, display, manifest, detect, record, reproduce, handle, or utilize any form of information, intelligence, or data for business, scientific, control, entertainment, or other purposes. For example, an information handling system may be a personal computer, a personal data assistant (PDA), a consumer electronic device, a network storage device, or any other suitable device and may vary in size, shape, performance, functionality, and price. The information handling system may include memory, one or more processing resources such as a central processing unit (CPU) or hardware or software control logic. Additional components of the information handling system may include one or more storage devices, one or more communications ports for communicating with external devices as well as various input and output (I/O) devices, such as a keyboard, a mouse, and a video display. The information handling system may also include one or more buses operable to transmit communication between the various hardware components.

For the purposes of this disclosure, computer-readable media may include any instrumentality or aggregation of instrumentalities that may retain data and/or instructions for a period of time. Computer-readable media may include, without limitation, storage media such as a direct access storage device (e.g., a hard disk drive or floppy disk), a sequential access storage device (e.g., a tape disk drive), compact disk, CD-ROM, DVD, random access memory (RAM), read-only memory (ROM), electrically erasable programmable read-only memory (EEPROM), and/or flash memory; as well as communications media such as wires, optical fibers, microwaves, radio waves, and other electromagnetic and/or optical carriers; and/or any combination of the foregoing.

For the purposes of this disclosure, information handling resources may broadly refer to any component system, device or apparatus of an information handling system, including without limitation processors, service processors, basic input/output systems (BIOSs), buses, memories, I/O devices and/or interfaces, storage resources, network interfaces, motherboards, power supplies, air movers (e.g., fans and blowers) and/or any other components and/or elements of an information handling system.

FIG. 1 illustrates a block diagram of an example system 100 which may represent at least a portion of components present in a data center environment. As shown in FIG. 1, system 100 may comprise a plurality of information handling systems 102, one or more power distribution units 104, a system manager 106, and a network 108 communicatively coupled to the information handling systems 102, power distribution units 104, and system manager 106. In some embodiments, system 100 as shown in FIG. 1 may represent a server rack, wherein system manager 106 may comprise a rack controller.

In some embodiments, each information handling system 102 may comprise a server. As shown in FIG. 1, each information handling system 102 may include at least one power supply unit (PSU) 110 configured to receive electrical energy from a corresponding power outlet of power distribution unit 104 in order to provide power to components of information handling system 102. Although FIG. 1 depicts each information handling system 102 having two PSUs 110, an information handling system 102 may include any suitable number of PSUs 110 each of which may be supplied electrical energy from a corresponding outlet of a power distribution unit 104.

Although FIG. 1 depicts system 100 having two power distribution units 104, system 100 may include any suitable number of power distribution units 104. In embodiments including a plurality of power distribution units 104, some power distribution units 104 may receive a different alternating current source as shown by “AC FEED 1” and “AC FEED 2” in FIG. 1.

Also as shown in FIG. 1, a system manager 106 for monitoring, control, and management of power distribution units 104 and information handling systems 102 may be coupled via network 108 to information handling systems 102 (e.g., via Ethernet).

Network 108 may be a network and/or fabric configured to couple system manager 106 to information handling systems 102, couple information handling systems 102 to one another, and/or couple one or more other information handling systems to system manager 106 and/or information handling systems 102. In these and other embodiments, network 108 may include a communication infrastructure, which provides physical connections, and a management layer, which organizes the physical connections and information handling systems communicatively coupled to network 108. Network 108 may be implemented as, or may be a part of, a storage area network (SAN), personal area network (PAN), local area network (LAN), a metropolitan area network (MAN), a wide area network (WAN), a wireless local area network (WLAN), a virtual private network (VPN), an intranet, the Internet or any other appropriate architecture or system that facilitates the communication of signals, data and/or messages (generally referred to as data). Network 108 may transmit data via wireless transmissions and/or wire-line transmissions using any storage and/or communication protocol, including without limitation, Fibre Channel, Frame Relay, Asynchronous Transfer Mode (ATM), Internet protocol (IP), other packet-based protocol, small computer system interface (SCSI), Internet SCSI (iSCSI), Serial Attached SCSI (SAS) or any other transport that operates with the SCSI protocol, advanced technology attachment (ATA), serial ATA (SATA), advanced technology attachment packet interface (ATAPI), serial storage architecture (SSA), integrated drive electronics (IDE), and/or any combination thereof. Network 108 and its various components may be implemented using hardware, software, or any combination thereof.

In addition to being configured to communicate over network 108, information handling systems 102 and system manager 106 may also be configured to communicate via power line communication (PLC). PLC is a communication technique that allows a modulated carrier signal to transmit data over an electrical conductor that is also being used to supply power. PLC may support multiple simultaneous connections using orthogonal frequency division multiplexing and may handle simultaneous communication among system manager 106 and information handling systems 102. Accordingly, power distribution units 104 and PSUs 110 may include appropriate components (e.g., network interfaces) to enable PLC.

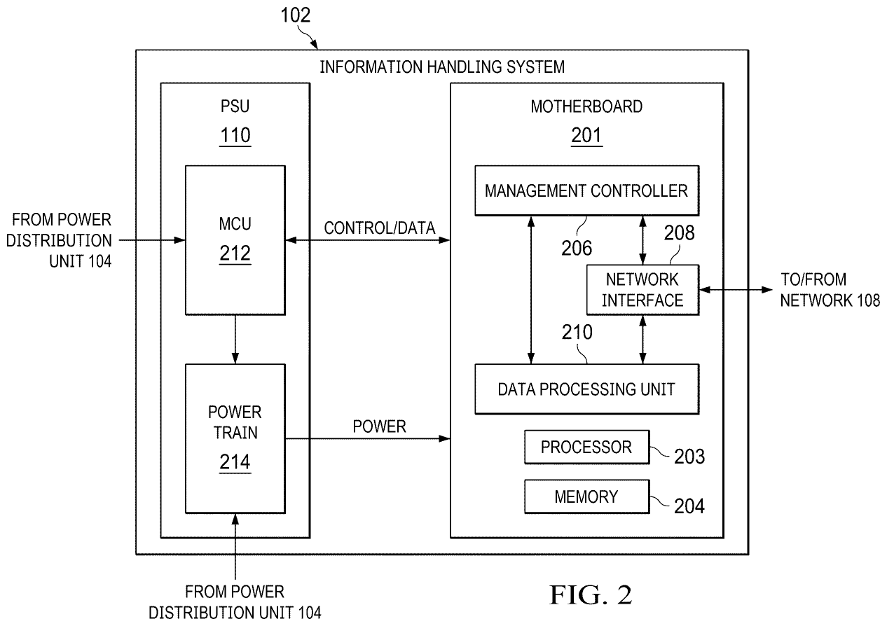

FIG. 2 illustrates a block diagram of an example of an information handling system 102. As depicted, information handling system 102 may include PSU 110, a motherboard 201, and one or more other information handling resources.

Motherboard 201 may include a circuit board configured to provide structural support for one or more information handling resources of information handling system 102 and/or electrically couple one or more of such information handling resources to each other and/or to other electric or electronic components external to information handling system 102. As shown in FIG. 2, motherboard 201 may include a processor 203, memory 204, a management controller 206, a network interface 208, a data processing unit 210, and one or more other information handling resources.

Processor 203 may comprise any system, device, or apparatus operable to interpret and/or execute program instructions and/or process data, and may include, without limitation a microprocessor, microcontroller, digital signal processor (DSP), application specific integrated circuit (ASIC), or any other digital or analog circuitry configured to interpret and/or execute program instructions and/or process data. In some embodiments, processor 203 may interpret and/or execute program instructions and/or process data stored in memory 204 and/or another component of information handling system 102.

Memory 204 may be communicatively coupled to processor 203 and may comprise any system, device, or apparatus operable to retain program instructions or data for a period of time. Memory 204 may comprise random access memory (RAM), electrically erasable programmable read-only memory (EEPROM), a PCMCIA card, flash memory, magnetic storage, opto-magnetic storage, or any suitable selection and/or array of volatile or non-volatile memory that retains data after power to information handling system 102 is turned off.

Management controller 206 may be configured to provide out-of-band management facilities for management of information handling system 102. Such management may be made by management controller 206 even if information handling system 102 is powered off or powered to a standby state. Management controller 206 may include a processor, memory, and out-of-band network interface separate from and physically isolated from an in-band network interface of information handling system 102, and/or other embedded information handling resources. In certain embodiments, management controller 206 may include or may be an integral part of a baseboard management controller (BMC) or a remote access controller (e.g., a Dell Remote Access Controller or Integrated Dell Remote Access Controller). In other embodiments, management controller 206 may include or may be an integral part of a chassis management controller (CMC). In some embodiments, management controller 206 may be configured to communicate with PSU 110 to communicate control and/or telemetry data between the two. Further, in these and other embodiments, management controller 206 may be configured to communicate with PSU 110 to receive and/or transmit power line communications.

Network interface 208 may comprise any suitable system, apparatus, or device operable to serve as an interface between information handling system 102 and another information handling system (e.g., system manager 106) and/or a network (e.g., network 108). Network interface 208 may enable information handling system 102 to communicate using any suitable transmission protocol and/or standard. In some embodiments, network interface 208 may be configured to communicate with other information handling systems via one or more protocols or standards discussed above with respect to network 108. In these and other embodiments, network interface 208 may comprise a network interface card, or “NIC.”

Data processing unit 210 may include any system, device, or apparatus that comprises a specialized card or other peripheral with its own processor, local storage, and operating system stored on such local storage, and may in essence function itself as an information handling system. In some embodiments, data processing unit 210 may also be known as a smartNIC, infrastructure processing unit (IPU), functional accelerator card (FAC), functional off-load coprocessor (FOCP), or distributed services card (DSC). Data processing unit 210 may be leveraged to offload storage and compute tasks from processor 203.

Generally speaking, PSU 110 may include any system, device, or apparatus configured to supply electrical current to one or more information handling resources of information handling system 102. As shown in FIG. 2, PSU 110 may include one or more microcontroller units (MCUs) 212 and a power train 214.

An MCU 212 may comprise a microprocessor, DSP, ASIC, FPGA, EEPROM, or any combination thereof, or any other device, system, or apparatus for controlling operation of its associated PSU 110. As such, an MCU 212 may comprise firmware, logic, and/or data for controlling functionality of such PSU 110. In some embodiments, MCU 212 may also include network interface hardware, firmware, and/or software (e.g., similar to network interface 208) to facilitate receipt and transmission of data via PLC between information handling system 102 and other information handling systems (e.g., system manager 106 and/or information handling systems 102).

Power train 214 may include any suitable system, device, or apparatus for converting electrical energy received from power distribution unit 104 (e.g., a 120-volt alternating current voltage waveform) into electrical energy usable to information handling resources of information handling system 102 (e.g., 12-volt direct current voltage source).

In addition to motherboard 201, processor 203, memory 204, management controller 206, network interface 208, and PSU 110, information handling system 102 may include one or more other information handling resources. Further, system manager 106 may comprise an information handling system, and thus may include some or all of the components shown in FIG. 2, components similar to some or all of the components shown in FIG. 2, and/or other suitable components.

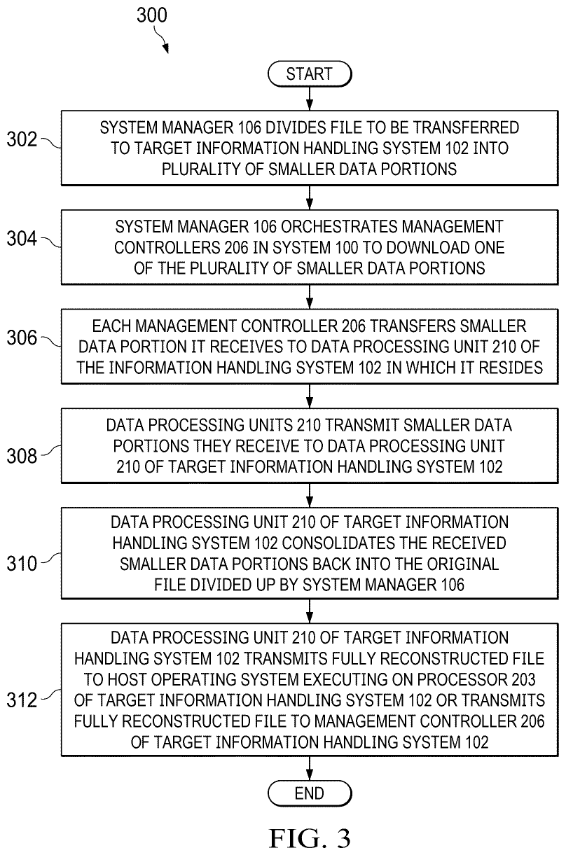

FIG. 3 illustrates a flow chart of an example method 300 for enhanced power line communication with data processing units, in accordance with embodiments of the present disclosure. In particular, method 300 may be used to transfer a file (e.g., a large file such as an optical disc image, more often commonly referred to as an ISO file) from system manager 106 to a management controller 206 of a target information handing system 102.

According to certain embodiments, method 300 may begin at step 302. As noted above, teachings of the present disclosure may be implemented in a variety of configurations of system 100. As such, the preferred initialization point for method 300 and the order of the steps comprising method 300 may depend on the implementation chosen.

At step 302, system manager 106 may divide a file (or other data) to be transferred to the target information handling system 102 into a plurality of smaller data portions, each portion including suitable tags for identification of the portions.

At step 304, system manager 106 may orchestrate management controllers 206 of the various information handling systems 102 in system 100 to download one of the plurality of smaller data portions.

At step 306, each management controller 206 may transfer the smaller data portion it receives to the data processing unit 210 of the information handling system 102 in which it resides. Such transfer may be via a third network channel internal to information handling system 102 (i.e., wherein the first and second network channels are the PLC channel and network 108).

At step 308, the various data processing units 210 (other than the data processing unit 210 of the target information handling system 102) may transmit the smaller data portions it receives to the data processing unit 210 of the target information handling system 102. In some embodiments, such transmission may be via network 108.

At step 310, the data processing unit 210 of the target information handling system 102 may consolidate the received smaller data portions back into the original file divided up by system manager 106, by using embedded identification tags.

At step 312, the data processing unit 210 of the target information handling system 102 may transmit the fully reconstructed file to a host operating system executing on processor 203 of the target information handling system 102 (e.g., via Non-Volatile Memory Enhanced standard or other suitable standard) or transmit the fully reconstructed file to management controller 206 of the target information handling system 102 (e.g., via the third network channel discussed above). After completion of step 312, method 300 may end.

Although FIG. 3 discloses a particular number of steps to be taken with respect to method 300, method 300 may be executed with greater or fewer steps than those depicted in FIG. 3. In addition, although FIG. 3 discloses a certain order of steps to be taken with respect to method 300, the steps comprising method 300 may be completed in any suitable order.

Method 300 may be implemented using system 100, components thereof or any other system operable to implement method 300. In certain embodiments, method 300 may be implemented partially or fully in software and/or firmware embodied in computer-readable media.

In an alternative method, steps 302 through 306 may be replaced by alternative steps. For example, in a first alternative step, system manager 106 may communicate a message to the management controller 206 of the target information handling system 102, wherein such message may include an identifier of the target information handling system 102 and a file path of the data to be transferred to the target information handling system 102. In a second alternative step, the management controller 206 of the target information handling system 102 may relay the file path to the various data processing units 210 in system 100 (e.g., via the third network channel discussed above and network 108). In a third alternative step, the various data processing units 210 in system 100 may, in concert, download the file in respective data portions. Then, the alternative method may proceed to steps 308 to 312 described above.

As used herein, when two or more elements are referred to as “coupled” to one another, such term indicates that such two or more elements are in electronic communication or mechanical communication, as applicable, whether connected indirectly or directly, with or without intervening elements.

This disclosure encompasses all changes, substitutions, variations, alterations, and modifications to the example embodiments herein that a person having ordinary skill in the art would comprehend. Similarly, where appropriate, the appended claims encompass all changes, substitutions, variations, alterations, and modifications to the example embodiments herein that a person having ordinary skill in the art would comprehend. Moreover, reference in the appended claims to an apparatus or system or a component of an apparatus or system being adapted to, arranged to, capable of, configured to, enabled to, operable to, or operative to perform a particular function encompasses that apparatus, system, or component, whether or not it or that particular function is activated, turned on, or unlocked, as long as that apparatus, system, or component is so adapted, arranged, capable, configured, enabled, operable, or operative. Accordingly, modifications, additions, or omissions may be made to the systems, apparatuses, and methods described herein without departing from the scope of the disclosure. For example, the components of the systems and apparatuses may be integrated or separated. Moreover, the operations of the systems and apparatuses disclosed herein may be performed by more, fewer, or other components and the methods described may include more, fewer, or other steps. Additionally, steps may be performed in any suitable order. As used in this document, “each” refers to each member of a set or each member of a subset of a set.

Although exemplary embodiments are illustrated in the figures and described above, the principles of the present disclosure may be implemented using any number of techniques, whether currently known or not. The present disclosure should in no way be limited to the exemplary implementations and techniques illustrated in the figures and described above.

Unless otherwise specifically noted, articles depicted in the figures are not necessarily drawn to scale.

All examples and conditional language recited herein are intended for pedagogical objects to aid the reader in understanding the disclosure and the concepts contributed by the inventor to furthering the art, and are construed as being without limitation to such specifically recited examples and conditions. Although embodiments of the present disclosure have been described in detail, it should be understood that various changes, substitutions, and alterations could be made hereto without departing from the spirit and scope of the disclosure.

Although specific advantages have been enumerated above, various embodiments may include some, none, or all of the enumerated advantages. Additionally, other technical advantages may become readily apparent to one of ordinary skill in the art after review of the foregoing figures and description.

To aid the Patent Office and any readers of any patent issued on this application in interpreting the claims appended hereto, applicants wish to note that they do not intend any of the appended claims or claim elements to invoke 35 U.S.C. § 112(f) unless the words “means for” or “step for” are explicitly used in the particular claim.

What is claimed is:

1. A system comprising:
a communications network; and
a plurality of information handling systems, wherein each information handling system of the plurality of information handling systems is communicatively coupled to the communications network, and each information handling system of the plurality of information handling systems comprises:
a processor; and
a data processing unit for offloading functions of the processor and configured to:
receive via the communications network a respective data portion of a file intended for a target information handling system of the plurality of information handling systems; and
transmit the respective data portion to the data processing unit of the target information handling system.

2. The system of claim 1, wherein the data processing unit of the target information handling system is further configured to:
consolidate the respective data portions back into the file; and
transmit the file to a destination component of the target information handling system.

3. The system of claim 2, wherein the destination component is a host system of the target information handling system.

4. The system of claim 2, wherein the destination component is a management controller of the target information handling system.

5. The system of claim 1, further comprising a system manager communicatively coupled to the plurality of information handling systems and configured to:
divide the file into the respective data portions; and
orchestrate download of the respective data portions to the plurality of information handling systems.

6. The system of claim 5, wherein each information handling system of the plurality of information handling systems further comprises a management controller configured to:
receive its respective data portion; and
transmit its respective data portion to a respective data processing unit of such information handling system.

7. The system of claim 1, further comprising:
a system manager communicatively coupled to the plurality of information handling systems and configured to communicate a message to a management controller of the target information handling system, wherein such message includes a file path for the file;
the management controller of the target information handling system is configured to communicate the file path to the data processing units of the plurality of information handling systems; and
the data processing units of the plurality of information handling systems are further configured to download their respective data portions.

8. The system of claim 1, wherein the system is a server rack.

9. A method, in a system comprising a communications network and a plurality of information handling systems, wherein each information handling system of the plurality of information handling systems is communicatively coupled to the communications network, and each information handling system of the plurality of information handling systems comprises a processor and a data processing unit for offloading functions of the processor, the method comprising:
receiving by the data processing unit of each information handling system, via the communications network, a respective data portion of a file intended for a target information handling system of the plurality of information handling systems; and
transmitting by the data processing unit of each information handling system, the respective data portion to the data processing unit of the target information handling system.

10. The method of claim 9, further comprising, by the data processing unit of the target information handling system:
consolidating the respective data portions back into the file; and
transmitting the file to a destination component of the target information handling system.

11. The method of claim 10, wherein the destination component is a host system of the target information handling system.

12. The method of claim 10, wherein the destination component is a management controller of the target information handling system.

13. The method of claim 9, further comprising, by a system manager communicatively coupled to the plurality of information handling systems:
dividing the file into the respective data portions; and
orchestrating download of the respective data portions to the plurality of information handling systems.

14. The method of claim 13, wherein each information handling system of the plurality of information handling systems further comprises a management controller and the method further comprises, by each management controller:
receiving its respective data portion; and
transmitting its respective data portion to a respective data processing unit of such information handling system.

15. The method of claim 9, further comprising:
by a system manager communicatively coupled to the plurality of information handling systems, communicating a message to a management controller of the target information handling system, wherein such message includes a file path for the file;
communicating by the management controller of the target information handling system the file path to the data processing units of the plurality of information handling systems; and
downloading, by the data processing units of the plurality of information handling systems, their respective data portions.

16. The method of claim 9, wherein the system is a server rack.
